(19) United States
(12) Patent Application Publication
(10) Pub. No.: US 2026/0365082 A1
(43) Pub. Date: Nov. 19, 2026

(54) FUEL CELL SYSTEM AND WORK VEHICLE

(71) Applicant: KOMATSU LTD., Tokyo (JP)

(72) Inventor: Tetsuo YOSHIDA, Tokyo (JP)

(21) Appl. No.: 19/132,179

(22) PCT Filed: Nov. 29, 2023
(86) PCT No.: PCT/JP2023/042728

§ 371 Date: May 22, 2025

(30) Foreign Application Priority Data
Dec. 15, 2022 (JP) 2022-200398

(51) Int. Cl. B60L 58/40; B60L 1/00; B60L 50/75

(52) U.S. Cl. CPC B60L 58/40; B60L 1/003; B60L 50/75

(57) ABSTRACT

A fuel cell system includes a fuel cell, an electric power storage device, an electric motor, an electric auxiliary device that operates the fuel cell, and a switch device. The electric motor is driven based on at least one of electric power from the fuel cell, and electric power from the electric power storage device. The switch device performs a switching operation of switching between supply of electric power from the fuel cell to the electric auxiliary device, and supply of electric power from the electric power storage device to the electric auxiliary device.

### CROSS-REFERENCE TO RELATED APPLICATIONS

This application is a U.S. National stage application of International Application No. PCT/JP 2023/042728, filed on Nov. 29, 2023. This U.S. National stage application claims priority under 35 U.S.C. § 119(a) to Japanese Patent Application No. 2022-200398, filed in Japan on Dec. 15, 2022, the entire contents of which are hereby incorporated herein by reference.

### BACKGROUND

### Technical Field

The disclosure relates to a fuel cell system and a work vehicle.

### Background Information

In a technical field related to fuel cell systems, an electric system of a fuel cell, such as that described in JP 2006-286320 A, is known.

### SUMMARY

As a characteristic of a fuel cell, it is known that efficiency of the fuel cell decreases as a load factor of the fuel cell increases. A fuel cell system also includes an electric auxiliary device for operating the fuel cell. When electric power generated by the fuel cell is used for the electric auxiliary device, there is a concern that the efficiency of the fuel cell may further decrease.

An object of the disclosure is to suppress a decrease in efficiency of a fuel cell system.

According to the disclosure, there is provided a fuel cell system including a fuel cell, an electric power storage device, an electric motor configured to be driven based on at least one of electric power from the fuel cell or electric power from the electric power storage device, an electric auxiliary device configured to operate the fuel cell, and a switch device configured to perform a switching operation of switching between supply of electric power from the fuel cell to the electric auxiliary device and supply of electric power from the electric power storage device to the electric auxiliary device.

According to the disclosure, a decrease in efficiency of the fuel cell system is suppressed.

### BRIEF DESCRIPTION OF DRAWINGS

FIG. 1 is a perspective view schematically illustrating a work vehicle according to an embodiment.

FIG. 2 is a diagram schematically illustrating a configuration of the work vehicle according to the embodiment.

FIG. 3 is a graph for describing characteristics of a fuel cell according to an embodiment.

FIG. 4 is a diagram schematically illustrating a part of a fuel cell system according to the embodiment.

### DETAILED DESCRIPTION OF EMBODIMENT(S)

Hereinafter, embodiments of the disclosure will be described with reference to the drawings, but the disclosure is not limited to the embodiments. Constituent elements of the embodiments, which will be described below, can be combined as appropriate. In addition, it is assumed that some constituent elements are not used in some cases.

### Work Vehicle

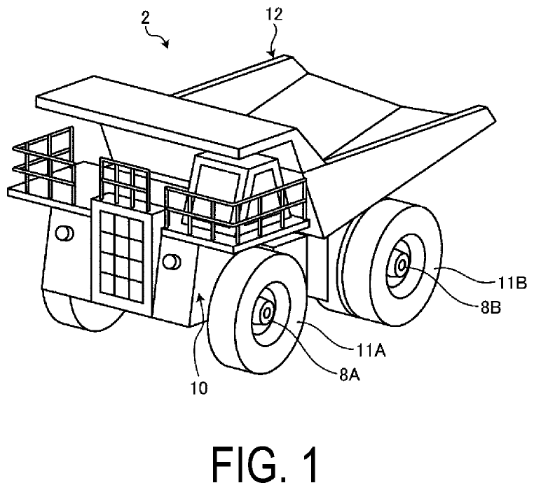

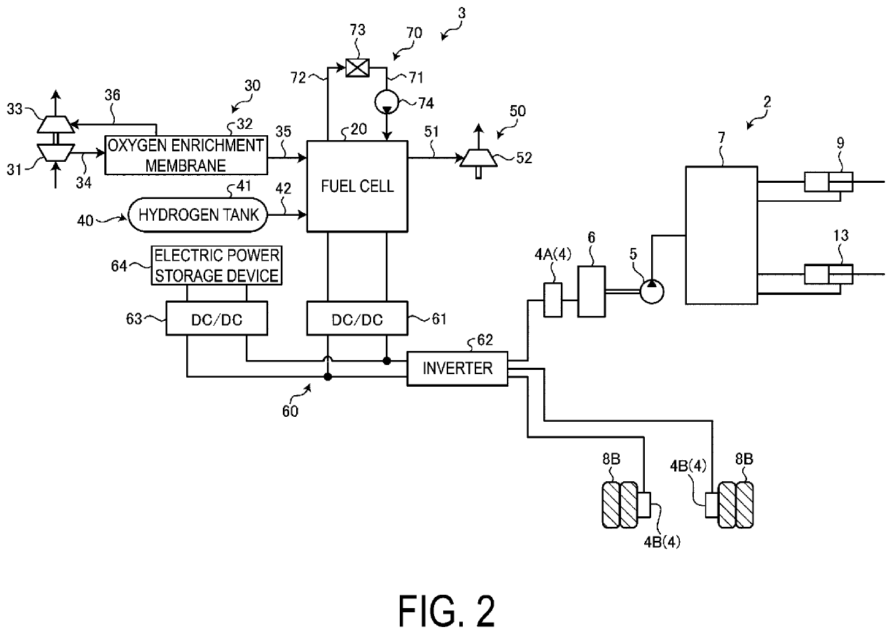

FIG. 1 is a perspective view schematically illustrating a work vehicle 2 according to an embodiment. FIG. 2 is a diagram schematically illustrating a configuration of the work vehicle 2 according to the embodiment. The work vehicle 2 refers to a vehicle for work at a work site. Examples of the work site include mines and quarries. In the embodiment, the work vehicle 2 is a transport vehicle for carrying work of carrying a load at the work site. The work vehicle 2 may be a manned vehicle that operates based on a driving operation by a driver on board the work vehicle 2, or may be an unmanned vehicle that operates in an unmanned state without depending on a driving operation by a driver. In the embodiment, the work vehicle 2 is appropriately referred to as a dump truck 2.

As illustrated in FIG. 1 and FIG. 2, the dump truck 2 includes a fuel cell system 3, an electric motor 4, a power take-off 6, a hydraulic pump 5, a valve device 7, front wheels 8A, rear wheels 8B, travel motors 4B, a steering cylinder 9, a vehicle body 10, a dump body 12, and a hoist cylinder 13.

The electric motor 4 is driven based on electric power generated by the fuel cell system 3. In the embodiment, the electric motor 4 includes a drive motor 4A and the travel motors 4B.

The hydraulic pump 5 is connected to the drive motor 4A with the power take-off 6 interposed therebetween. The drive motor 4A drives the hydraulic pump 5. The hydraulic pump 5 discharges hydraulic oil that is supplied to each of the steering cylinder 9 and the hoist cylinder 13. The hydraulic oil discharged from the hydraulic pump 5 is supplied to each of the steering cylinder 9 and the hoist cylinder 13 through the valve device 7.

The front wheels 8A and the rear wheels 8B support the vehicle body 10. A front tire 11A is mounted on the front wheel 8A. A rear tire 11B is mounted on the rear wheel 8B. Each of the front wheels 8A is a steered wheel steered by the steering cylinder 9. Each of the rear wheels 8B is a driven wheel that rotates by power generated by each corresponding travel motor 4B. The travel motors 4B respectively rotate the rear wheels 8B. The dump truck 2 travels by rotation of the rear tires 11B mounted on the rear wheels 8B.

The steering cylinder 9 is a hydraulic cylinder that is one type of hydraulic actuator. The steering cylinder 9 is driven based on the hydraulic oil discharged from the hydraulic pump 5. The valve device 7 adjusts a flow rate and a direction of the hydraulic oil to be supplied to the steering cylinder 9 from the hydraulic pump 5. The steering cylinder 9 generates power for steering the front wheels 8A.

The vehicle body 10 is supported by the front wheels 8A and the rear wheels 8B. The dump body 12 is supported by the vehicle body 10. The dump body 12 is a member on which a load is loaded. The dump body 12 is rotated by the hoist cylinder 13. The dump body 12 is of a rear dump type. When the dump body 12 is rotated rearward by the hoist cylinder 13, the load is discharged from the dump body 12.

The hoist cylinder 13 is a hydraulic cylinder that is one type of hydraulic actuator. The hoist cylinder 13 is driven based on the hydraulic oil discharged from the hydraulic pump 5. The valve device 7 adjusts a flow rate and a direction of the hydraulic oil to be supplied to the hoist cylinder 13 from the hydraulic pump 5. The hoist cylinder 13 generates power for rotating the dump body 12.

### Fuel Cell System

The fuel cell system 3 is mounted on the dump truck 2. As illustrated in FIG. 2, the fuel cell system 3 includes a fuel cell 20, an oxidization gas supply device 30, a fuel gas supply device 40, a gas emission device 50, an electric power adjustment device 60, and a coolant supply device 70.

The fuel cell 20 generates electric power by a chemical reaction between hydrogen as a fuel gas and oxygen as an oxidization gas. The fuel cell 20 has a stack structure in which a plurality of unit cells are stacked.

The oxidization gas supply device 30 supplies air containing oxygen to a cathode of the fuel cell 20. The oxidization gas supply device 30 includes an air compressor 31, an oxygen enrichment membrane 32, a turbine 33, an air supply line 34, an air supply line 35, and an air supply line 36. The air compressor 31 sucks air outside the dump truck 2 and then, supplies the air to the fuel cell 20. The turbine 33 is connected to the air compressor 31. The air supply line 34 connects the air compressor 31 and the oxygen enrichment membrane 32. The air sucked by the air compressor 31 is supplied to the oxygen enrichment membrane 32 through the air supply line 34. The oxygen enrichment membrane 32 generates, from air, oxygen-enriched air having an increased oxygen concentration and nitrogen-enriched air having a decreased oxygen concentration. The air supply line 35 connects the oxygen enrichment membrane 32 and a cathode inlet of the fuel cell 20. The oxygen-enriched air generated at the oxygen enrichment membrane 32 is supplied to the cathode of the fuel cell 20 through the air supply line 35. The air supply line 36 connects the oxygen enrichment membrane 32 and the turbine 33. The nitrogen-enriched air generated at the oxygen enrichment membrane 32 is supplied to the turbine 33 through the air supply line 36. The nitrogen-enriched air rotates the turbine 33. The turbine 33 applies a rotational force to the air compressor 31.

The fuel gas supply device 40 supplies hydrogen to an anode of the fuel cell 20. The fuel gas supply device 40 includes a hydrogen tank 41 and a fuel gas supply line 42. The hydrogen tank 41 accommodates the hydrogen. The hydrogen is filled into the hydrogen tank 41. The fuel gas supply line 42 connects the hydrogen tank 41 and an anode inlet of the fuel cell 20. The hydrogen delivered from the hydrogen tank 41 is supplied to the anode of the fuel cell 20 through the fuel gas supply line 42. Note that the fuel gas supply line 42 may be disposed with a hydrogen pump that supplies the hydrogen in the hydrogen tank 41 to the fuel cell 20.

The gas emission device 50 emits gas emitted from the fuel cell 20 to an atmospheric space around the dump truck 2. The gas emission device 50 includes an exhaust line 51 and a turbine 52. The exhaust line 51 connects a cathode outlet of the fuel cell 20 and the turbine 52. The turbine 52 is rotated by the gas emitted from the fuel cell 20.

The electric power adjustment device 60 includes a DC/DC converter 61, an inverter 62, a DC/DC converter 63, and an electric power storage device 64. The electric power adjustment device 60 supplies at least one of electric power generated by the fuel cell 20 or electric power stored in the electric power storage device 64 to each electric motor 4 (4A, 4B). The electric motor 4 is driven based on at least one of the electric power from the fuel cell 20 or the electric power from the electric power storage device 64.

The DC/DC converter 61 boosts a voltage generated by the fuel cell 20. The DC/DC converter 61 supplies a direct current generated by the fuel cell 20 to the inverter 62. The electric power storage device 64 is charged with electric power generated by the fuel cell 20. The electric power storage device 64 may be charged by a charging device provided outside the dump truck 2. The electric power storage device 64 may be charged by regenerative energy of the electric motor 4. The electric power storage device 64 includes a secondary battery (storage battery). In the embodiment, the electric power storage device 64 includes a lithium-ion battery (LiB). Note that the electric power storage device 64 may include a lithium-ion capacitor (LiC) or an electric double layer capacitor (EDLC). The DC/DC converter 63 controls charge and discharge of the electric power storage device 64 so that the electric power storage device 64, together with the fuel cell 20, can supply electric power to the inverter 62. The inverter 62 converts a direct current from at least one of the DC/DC converter 61 or the DC/DC converter 63 into a three-phase alternating current and then, supplies this current to each electric motor 4 (4A, 4B). Each electric motor 4 (4A, 4B) is driven based on the three-phase alternating current supplied from the inverter 62.

The coolant supply device 70 supplies a coolant to the fuel cell 20 in order to cool the fuel cell 20. As the coolant, water is exemplified. The coolant supply device 70 includes a supply line 71, a discharge line 72, a radiator 73, and a coolant pump 74. The supply line 71 is connected to a coolant inlet of the fuel cell 20. The discharge line 72 is connected to a coolant outlet of the fuel cell 20. The radiator 73 is connected to the supply line 71 and the discharge line 72. The coolant pump 74 is disposed at the supply line 71. The coolant pump 74 supplies a coolant to the fuel cell 20. The coolant pump 74 is driven such that the coolant circulates in a circulation path including the supply line 71, the fuel cell 20, the discharge line 72, and the radiator 73. The radiator 73 exchanges heat between the coolant discharged from the fuel cell 20 and air outside the dump truck 2 to cool the coolant.

### Characteristics of Fuel Cell

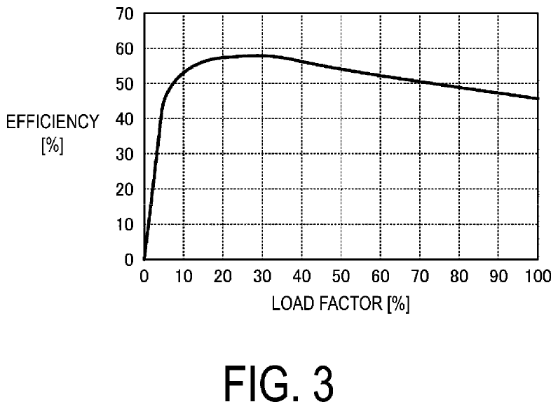

FIG. 3 is a graph for describing characteristics of the fuel cell 20 according to the embodiment. FIG. 3 shows a relationship between a load factor and an efficiency of the fuel cell 20. The load factor of the fuel cell 20 refers to a rate of an amount of electric power actually used with respect to an amount of electric power generated when the fuel cell 20 operates at a rated capacity (a capacity of 100% in design). The efficiency of the fuel cell 20 (efficiency of electric power generation) refers to a rate at which renewable energy (hydrogen) input to the fuel cell 20 is converted into electric energy. In FIG. 3, the efficiency is an efficiency of the fuel cell 20 alone. As shown in FIG. 3, as the load factor of the fuel cell 20 increases, the efficiency of the fuel cell 20 decreases. That is, as the used amount of electric power generated by the fuel cell 20 increases, the efficiency of the fuel cell 20 decreases. As shown in FIG. 3, when the load factor of the fuel cell 20 is equal to or more than 20% and equal to or less than 30%, the efficiency of the fuel cell 20 becomes high. As the load factor of the fuel cell 20 becomes higher than 30%, the efficiency of the fuel cell 20 gradually decreases. Furthermore, when the load factor of the fuel cell 20 falls below 10%, the efficiency of the fuel cell 20 rapidly decreases.

The fuel cell system 3 includes an electric auxiliary device for operating the fuel cell 20. In the example illustrated in FIG. 2, the electric auxiliary device includes at least one of the air compressor 31 that supplies air to the fuel cell 20 or the coolant pump 74 that supplies a coolant to the fuel cell 20. Note that when a hydrogen pump that supplies hydrogen in the hydrogen tank 41 to the fuel cell 20 is disposed at the fuel gas supply line 42, the electric auxiliary device may include the hydrogen pump. When electric power generated by the fuel cell 20 is used not only for the electric motor 4 but also for the electric auxiliary device, the load factor of the fuel cell 20 increases. When the load factor of the fuel cell 20 increases, the efficiency of the fuel cell 20 decreases.

In the embodiment, the fuel cell system 3 switches between supply of electric power from the fuel cell 20 to the electric auxiliary device and supply of electric power from the electric power storage device 64 to the electric auxiliary device, thereby suppressing the usage of the electric power generated by the fuel cell 20 for the electric auxiliary device. By suppressing the usage of the electric power generated by the fuel cell 20 for the electric auxiliary device, an increase in the load factor of the fuel cell 20 is suppressed, so that a decrease in the efficiency of the fuel cell 20 is suppressed.

### Switch Device

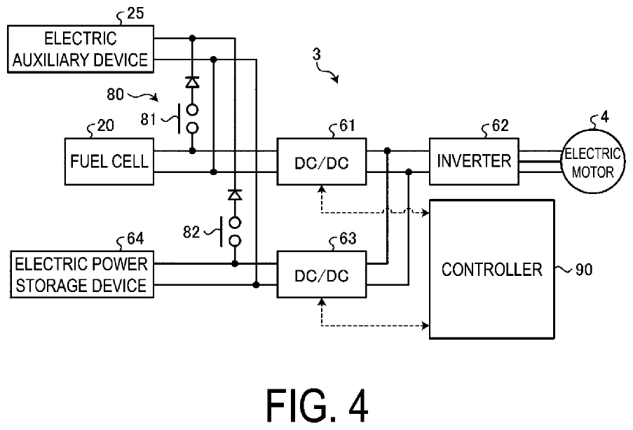

FIG. 4 is a diagram schematically illustrating a part of the fuel cell system 3 according to the embodiment. As illustrated in FIG. 4, the fuel cell system 3 includes the fuel cell 20, the electric power storage device 64, the electric motor 4, the electric auxiliary device 25, the DC/DC converter 61, the DC/DC converter 63, the inverter 62, a switch device 80, and a controller 90.

The electric motor 4 is driven based on at least one of electric power from the fuel cell 20 or electric power from the electric power storage device 64. As described above, the electric motor 4 includes the drive motor 4A for driving the hydraulic pump 5 and the travel motors 4B for rotating the rear wheels 8B.

The DC/DC converter 61 boosts a voltage generated by the fuel cell 20. The DC/DC converter 63 controls charge and discharge of the electric power storage device 64 so that the electric power storage device 64, together with the fuel cell 20, can supply electric power to the inverter 62. The inverter 62 converts a direct current from at least one of the DC/DC converter 61 or the DC/DC converter 63 into a three-phase alternating current and then, supplies this current to the electric motor 4. The electric motor 4 is driven based on the three-phase alternating current supplied from the inverter 62.

The electric auxiliary device 25 is driven in order to operate the fuel cell 20. The electric auxiliary device 25 is driven based on at least one of the electric power from the fuel cell 20 or the electric power from the electric power storage device 64.

The fuel cell 20 and the electric power storage device 64 are connected in parallel to each other with respect to the electric motor 4. The electric auxiliary device 25 is connected in parallel to the fuel cell 20 and the electric power storage device 64.

The switch device 80 performs a switching operation of switching between supply of electric power from the fuel cell 20 to the electric auxiliary device 25 and supply of electric power from the electric power storage device 64 to the electric auxiliary device 25. The switch device 80 includes a first switch 81 disposed between the fuel cell 20 and the electric auxiliary device 25, and a second switch 82 disposed between the electric power storage device 64 and the electric auxiliary device 25. The controller 90 controls the switch device 80. When the first switch 81 is turned on, and thus, the fuel cell 20 and the electric auxiliary device 25 are connected to each other, electric power is supplied from the fuel cell 20 to the electric auxiliary device 25. When the first switch 81 is turned off, and thus, the connection between the fuel cell 20 and the electric auxiliary device 25 is released, the supply of the electric power from the fuel cell 20 to the electric auxiliary device 25 is cut off. When the second switch 82 is turned on, and thus, the electric power storage device 64 and the electric auxiliary device 25 are connected to each other, electric power is supplied from the electric power storage device 64 to the electric auxiliary device 25. When the second switch 82 is turned off, and thus, the connection between the electric power storage device 64 and the electric auxiliary device 25 is released, and also the supply of the electric power from the electric power storage device 64 to the electric auxiliary device 25 is cut off.

The controller 90 performs the switching operation of the switch device 80 based on a load factor of the fuel cell 20. The controller 90 can monitor the load factor of the fuel cell 20 based on an operating state of the DC/DC converter 61.

When the load factor of the fuel cell 20 is equal to or larger than a predetermined threshold value, the controller 90 performs the switching operation of the switch device 80 such that electric power is supplied from the electric power storage device 64 to the electric auxiliary device 25 and electric power is not supplied from the fuel cell 20 to the electric auxiliary device 25. As an example, in a case where the threshold value related to the load factor is 60%, the controller 90 turns off the first switch 81 and turns on the second switch 82 when the load factor of the fuel cell 20 is equal to or more than 60% and equal to or less than 100%. In a case where the load factor of the fuel cell 20 is high, no electric power is supplied from the fuel cell 20 to the electric auxiliary device 25, so that the electric power generated by the fuel cell 20 is not used for the electric auxiliary device 25 but is used for the electric motor 4. The electric auxiliary device 25 is driven based on the electric power supplied from the electric power storage device 64. Since the electric power generated by the fuel cell 20 is not used for the electric auxiliary device 25, an increase in the load factor of the fuel cell 20 is suppressed. Since the increase in the load factor of the fuel cell 20 is suppressed, a decrease in the efficiency of the fuel cell 20 is suppressed.

When the load factor of the fuel cell 20 is less than the predetermined threshold value, the controller 90 performs the switching operation of the switch device 80 such that electric power is supplied from the fuel cell 20 to the electric auxiliary device 25 and electric power is not supplied from the electric power storage device 64 to the electric auxiliary device 25. When the load factor of the fuel cell 20 is equal to or more than 0% and less than 60%, the controller 90 turns on the first switch 81 and turns off the second switch 82. When the load factor of the fuel cell 20 is low, electric power is not supplied from the electric power storage device 64 to the electric auxiliary device 25, so that consumption of electric power charged in the electric power storage device 64 is suppressed. The electric auxiliary device 25 is driven based on the electric power supplied from the fuel cell 20.

As described above, according to the embodiment, the fuel cell system 3 includes the fuel cell 20, the electric power storage device 64, the electric motor 4 configured to be driven based on at least one of electric power from the fuel cell 20 or electric power from the electric power storage device 64, the electric auxiliary device 25 configured to operate the fuel cell 20, and the switch device 80 configured to perform a switching operation of switching between supply of electric power from the fuel cell 20 to the electric auxiliary device 25 and supply of electric power from the electric power storage device 64 to the electric auxiliary device 25.

According to the embodiment, since the electric power generated by the fuel cell 20 is not always used for the electric auxiliary device 25, an increase in the load factor of the fuel cell 20 is suppressed. Since the increase in the load factor of the fuel cell 20 is suppressed, a decrease in the efficiency of the fuel cell 20 is suppressed. Since the decrease in the efficiency of the fuel cell 20 is suppressed, a decrease in the efficiency of the fuel cell system 3 is suppressed.

The switch device 80 performs the switching operation based on the load factor of the fuel cell 20. When the load factor of the fuel cell 20 is equal to or larger than the threshold value, the switching operation is performed such that electric power is supplied from the electric power storage device 64 to the electric auxiliary device 25, thereby suppressing a further increase in the load factor of the fuel cell 20. When the load factor of the fuel cell 20 is less than the threshold value, the switching operation is performed such that electric power is supplied from the fuel cell 20 to the electric auxiliary device 25, thereby suppressing consumption of electric power charged in the electric power storage device 64.

The electric auxiliary device 25, the fuel cell 20, and the electric power storage device 64 are connected in parallel. Thus, the switching operation is smoothly performed without complicating the structure of the fuel cell system 3.

1. A fuel cell system comprising:
a fuel cell;
an electric power storage device;
an electric motor configured to be driven based on at least one of electric power from the fuel cell, and
electric power from the electric power storage device;
an electric auxiliary device configured to operate the fuel cell; and
a switch device configured to perform a switching operation of switching between supply of electric power from the fuel cell to the electric auxiliary device, and supply of electric power from the electric power storage device to the electric auxiliary device.

2. The fuel cell system according to claim 1, wherein
the switch device performs the switching operation based on a load factor of the fuel cell.

3. The fuel cell system according to claim 2, wherein
when the load factor of the fuel cell is equal to or larger than a threshold value, the switch device performs the switching operation of switching to the supply of the electric power from the electric power storage device to the electric auxiliary device.

4. The fuel cell system according to claim 2, wherein
when the load factor of the fuel cell is less than a threshold value, the switch device performs the switching operation of switching to the supply of the electric power from the fuel cell to the electric auxiliary device.

5. The fuel cell system according to claim 1, wherein
the fuel cell and the electric power storage device are connected in parallel to each other with respect to the electric motor, and
the electric auxiliary device is connected in parallel to the fuel cell and the electric power storage device.

6. The fuel cell system according to claim 1, wherein
the electric auxiliary device includes at least one of
an air compressor configured to supply air to the fuel cell, and
a coolant pump configured to supply a coolant to the fuel cell.

7. A work vehicle including the fuel cell system according to claim 1.

8. The work vehicle according to claim 7, further comprising:
a wheel,
the electric motor being configured to rotate the wheel.

9. The work vehicle according to claim 7, further comprising:
a hydraulic cylinder; and
a hydraulic pump configured to discharge hydraulic oil to be supplied to the hydraulic cylinder,
the electric motor being configured to drive the hydraulic pump.
